(19) United States
(12) Patent Application Publication
(10) Pub. No.: US 2010/0097387 A1
(43) Pub. Date: Apr. 22, 2010

(54) Rendering method to improve image resolution

(75) Inventors: Yun-Tae Kim, Suwon-si (KR); Gee Young Sung, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/385,512

(22) Filed: Apr. 9, 2009

(30) Foreign Application Priority Data
Oct. 21, 2008 (KR) 10-2008-0102930

(51) Int. Cl. G09G 5/00

(52) U.S. Cl. 345/581

(57) ABSTRACT

A rendering method is provided. The rendering method forms a pixel structure in which a plurality of red, green, blue, and white (RGBW) sub pixels is arranged in a predetermined pattern, and renders a plurality of pixels which configure an image using the plurality of RGBW sub pixels on a display.

### CROSS-REFERENCE TO RELATED APPLICATIONS

This application claims the benefit of Korean Patent Application No. 10-2008-0102930, filed on Oct. 21, 2008, in the Korean Intellectual Property Office, the disclosure of which is incorporated herein by reference.

### BACKGROUND

1. Field

Example embodiments relate to a rendering method, and more particularly, to a rendering method capable of improving brightness and a resolution of an image by rendering pixels configuring the image via a pixel structure which uses red, green, blue, and white (RGBW) sub pixels.

2. Description of the Related Art

With the dramatic increase of techniques related to displays, various research and studies on improving a quality of an image to be displayed via the displays are being conducted.

In particular, many research and studies on a technique providing viewers with high quality images are being conducted.

Recently, as three-dimensional (3D) images are being focused on, techniques for realization of the 3D image and conversion of 3D images and two-dimension (2D) images have been introduced.

In general, it is known that a human experiences a 3D effect mostly due to binocular disparity between both eyes. Accordingly, a 3D image may be realized using such human feature. As an example, to display an object as a 3D image, an image viewed via a left eye and an image viewed via a right eye are simultaneously displayed, thereby enabling a viewer to perceive the object as being a 3D image.

Although 3D images may provide realism to a viewer, conventional techniques of realizing 3D images may deteriorate brightness or a resolution of the images and may not provide viewers with a high quality of images.

In particular, 3D images with multiple viewpoints may have a deteriorated resolution due to a number of viewpoints, and therefore, a new technique capable of preventing resolution deterioration of 3D images is required.

### SUMMARY

According to example embodiments, there may be provided a rendering method including: forming a pixel structure in which a plurality of red, green, blue, and white (RGBW) sub pixels is arranged in a checkerboard pattern; and rendering a plurality of pixels which configure an image using the plurality of RGBW sub pixels on a display.

According to another example embodiment, there may be provided a rendering method including: forming a pixel structure in which a plurality of RGBW sub pixels is arranged in a striped pattern; and rendering a plurality of pixels which configure an image using the plurality of RGBW sub pixels on a display.

Brightness and a resolution of the image may be improved by rendering an image in a predefined pattern via a pixel structure using RGBW sub pixels.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of example embodiments will become apparent and more readily appreciated from the following description, taken in conjunction with the accompanying drawings of which:

FIG. 1 is a flowchart illustrating a rendering method according to an example embodiment;

FIG. 2 is a diagram illustrating an example of a pixel structure in which sub pixels are arranged in a checkerboard pattern according to an example embodiment;

FIG. 3 is a diagram illustrating another example of a pixel structure in which sub pixels are arranged in a checkerboard pattern according to an example embodiment;

FIG. 4 is a diagram illustrating still another example of a pixel structure in which sub pixels are arranged in a checkerboard pattern according to an example embodiment;

FIG. 5 is a flowchart illustrating a rendering method according to another example embodiment; and

FIG. 6 is a diagram illustrating a pixel structure in which sub pixels are arranged in a stripe pattern according to an example embodiment.

### DETAILED DESCRIPTION OF EMBODIMENTS

Reference will now be made in detail to example embodiments, examples of which are illustrated in the accompanying drawings, wherein like reference numerals refer to the like elements throughout. Example embodiments are described below to explain the present disclosure by referring to the figures.

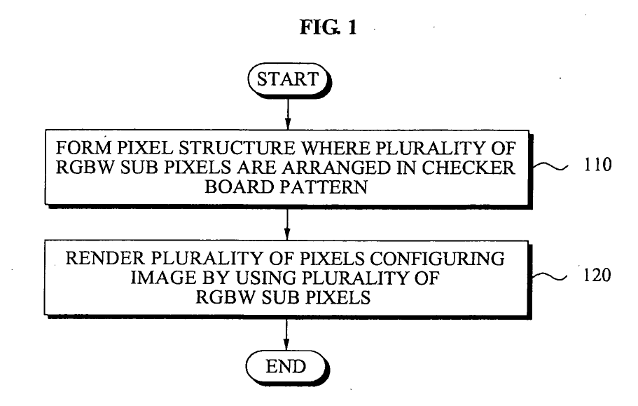

FIG. 1 is a flowchart illustrating a rendering method according to an example embodiment.

In operation 110, a pixel structure in which a plurality of red, green, blue, and white (RGBW) sub pixels is arranged in a checkerboard pattern is formed.

In operation 120, a plurality of pixels configuring an image is rendered using the plurality of RGBW sub pixels.

According to an example embodiment, the plurality of pixels may be rendered by grouping the plurality of RGBW sub pixels in a diagonal direction on the pixel structure in operation 120.

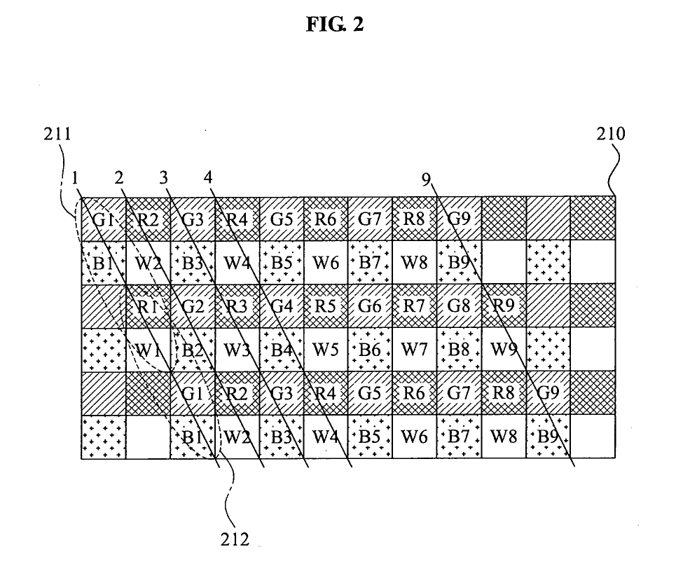

Hereinafter, the operations of rendering the plurality of pixels by grouping the plurality of RGBW sub pixels in the diagonal direction on the pixel structure are described in detail with respect to FIG. 2.

FIG. 2 is a diagram illustrating an example of a pixel structure 210 in which sub pixels are arranged in a checkerboard pattern according to an example embodiment.

In operation 110 of FIG. 1, the pixel structure 210 is formed in which the plurality of RGBW sub pixels is arranged in the checkerboard pattern.

In operation 120, the plurality of pixels configuring the image is rendered by grouping the plurality of RGBW sub pixels in the diagonal direction on the pixel structure 210.

Detailed descriptions regarding the above context using the pixel structure 210 are as follows. The RGBW sub pixels are grouped into patterns in the diagonal direction, such as (G1, B1, R1, W1), (R2, W2, G2, B2), . . . , (G9, B9, R9, W9), etc., and the plurality of pixels may be rendered using the grouped sub pixels.

The pixel structure 210 is a pixel structure in which nine sub pixels from a line 1 (G1, B1, R1, W1) to a line 9 (G9, B9, R9, W9) are arranged in a diagonal direction, and which may be used to render the plurality of pixels configuring a multi-view 3D image.

The pixel structure 210 may be used to render a nine-view 3D image since the nine sub pixels are arranged in the diagonal direction. As an example, a line corresponding to (G1, B1, R1, W1) 211 may correspond to first 3D pixel data at a first viewpoint of the 3D image.

In general, a resolution of a multi-view 3D image may be decreased by up to a number of its viewpoints. However, the rendering method according to the example embodiments may prevent resolution deterioration caused by multi-viewpoints by locating sub pixels in a diagonal direction on the pixel structure, grouping the sub pixels in the diagonal direction, and rendering a plurality of pixels configuring a multi-view 3D image, thereby preventing resolution deterioration caused by the multi-viewpoints.

Also, the rendering method according to the example embodiments may improve brightness of an image by using RGBW sub pixels instead of using RGB sub pixels.

In this instance, the rendering method according to the example embodiments may convert RGB input signals into RGBW input signals. Here, the operations of converting the RGB input signals into the RGBW input signals may be performed by using Equation 1,

$${R}_{out} = {R}_{i n} ↵ \\ {G}_{out} = {G}_{i n} ↵ \\ {B}_{out} = {B}_{i n} ↵ \\ {W}_{out} = Min ( Ri , Gi , Bi ) . \qquad [ Equation 1 ]$$

Also, according to the example embodiments, in operation 120, the plurality of pixels may be rendered by sharing sub pixels which are adjacent to each other on the pixel structure 210.

Referring to FIG. 2, the plurality of RGBW sub pixels are grouped in a diagonal direction on the pixel structure 210, and the plurality of RGBW sub pixels may be grouped sharing sub pixels (R1, W1) as (G1, B1, R1, W1) 211 and (R1, W1, G1, B1) 212 do. A resolution of an image may be improved by rendering pixels using (G1, B1, R1, W1) 211 and (R1, W1, G1, B1) 212 having shared sub pixels (R1, W1) which are adjacent to each other. In detail, in operation 120, the plurality of pixels may be rendered by grouping the RGBW sub pixels into the checkerboard pattern on the pixel structure 210. A resolution of an image may be improved by rendering pixels by using (G1, B1, R1, W1) 211 and (R1, W1, G1, B1) 212 which share sub pixels (R1, W1) adjacent to each other. That is, in the pixel structure 210 of FIG. 2, (Rn, Wn) and (Gn, Bn) are shared in a diagonal direction, thereby improving a resolution of an image.

According to the example embodiments, in operation 120, the plurality of pixels may be rendered by grouping the plurality of RGBW sub pixels into the checkerboard pattern on the pixel structure 210.

In this instance, the pixel structure 210 may be used to render the plurality of pixels which configure a 2D image, and may be used to render the plurality of pixels by grouping sub pixels into patterns of (G1, R2, B1, W2), (G3, R4, B3, W4), (G5, R6, B5, W6), etc.

According to the example embodiments, in operation 120, the plurality of pixels may be rendered by sharing sub pixels adjacent to each other on the pixel structure 210.

As an example, a resolution of a 2D image may be improved by grouping sub pixels into patterns of (G1, R2, B1, W2), (R2, G3, W2, B3), (G3, R4, B3, W4), etc. and rendering the plurality of pixels.

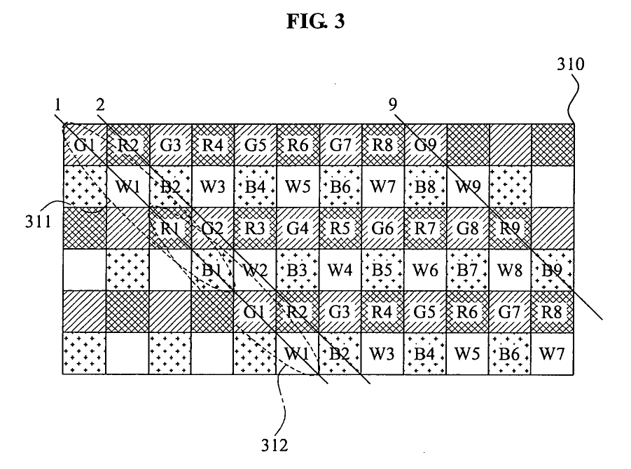

Hereinafter, a pixel structure where sub pixels are arranged in a diagonal direction, in a pattern different from the structure 210, is described with respect to FIG. 3.

FIG. 3 is a diagram illustrating another example of a pixel structure 310 in which sub pixels are arranged in a checkerboard pattern according to an example embodiment.

Referring to the pixel structure 310, sub pixels are arranged in a diagonal direction as shown in the pixel structure 210, however the sub pixels are arranged in different diagonal patterns on the pixel structure 210.

According to the example embodiments, in operation 120, a plurality of pixels configuring an image may be rendered by grouping sub pixels in a diagonal direction on the pixel structure 310, such as (G1, W1, R1, B1), (R2, B2, G2, W2), etc.

Here, a line corresponding to (G1, W1, R1, B1) may correspond to first 3D pixel data at a first viewpoint of a multi-view 3D image, and a line corresponding to (R2, B2, G2, W2) may correspond first 3D pixel data at a second viewpoint of the multi-view 3D image.

Also, according to the example embodiments, in operation 120, the plurality of pixels configuring an image may be rendered by grouping sub pixels into a checkerboard pattern on the pixel structure 310, such as patterns of (G1, R2, B1, W1), (G3, R4, B2, W3), etc. Here, the pixel structure 310 may be used to render a plurality of pixels configuring a 2D image.

Also, according to the example embodiments, in operation 120, the plurality of pixels may be rendered by sharing pixels which are adjacent to each other on the pixel structure 310.

As an example, the plurality of pixels may be rendered by grouping sub pixels, such as in (G1, W1, R1, B1) 311 and (R1, B1, G1, W1) 312.

From the above, the operations of rendering the plurality of pixels configuring the image by grouping the plurality of RGBW sub pixels in the diagonal direction have been described in detail with respect to FIGS. 2 and 3.

However, according the example embodiments, the plurality of pixels may be rendered by grouping the plurality of RGBW sub pixels in a perpendicular direction, as well as in the diagonal direction.

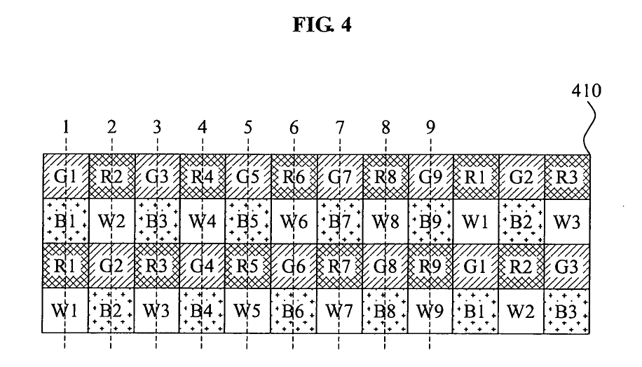

FIG. 4 is a diagram illustrating still another example of a pixel structure 410 in which sub pixels are arranged in a checkerboard pattern according to example embodiments.

According to example embodiments, the pixel structure 410 may be used to render a plurality of pixels configuring a multi-view 3D image, and a plurality of RGBW sub pixels may be arranged in a perpendicular direction.

Here, a line corresponding to (G1, B1, R1, W1) may correspond to first 3D pixel data at a first viewpoint of a multi-view 3D image, and a line corresponding to (R2, W2, G2, B2) may correspond to first 3D pixel data at a second viewpoint of the multi-view 3D image.

According to example embodiments, in operation 120, on the pixel structure 410, the plurality of pixels configuring an image may be rendered by grouping sub pixels in a perpendicular direction, as (G1, B1, R1, W1), (R2, W2, G2, B2), etc.

Also, according to example embodiments, in operation 120, the plurality of pixels configuring the image may be rendered by grouping sub pixels into the checkerboard pattern on the pixel structure 410, such as (G1, R2, B1, W2), (G3, R4, B3, W4), etc. Here, the pixel structure 410 may be used to render the plurality of pixels configuring a 2D image.

Also, according to example embodiments, in operation 120, on the pixel structure 410, the plurality of pixels configuring the image may be rendered by sharing sub pixels which are adjacent to each other.

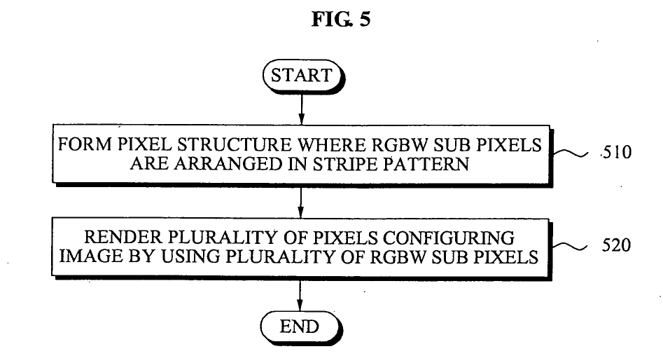

FIG. 5 is a flowchart illustrating a rendering method according to another example embodiment.

In operation 510, a pixel structure in which a plurality of RGBW sub pixels is arranged in a stripe pattern is formed.

In operation 520, a plurality of pixels configuring an image is rendered using the plurality of RGBW sub pixels.

According to example embodiments, the plurality of RGBW sub pixels is grouped in a diagonal direction on the pixel structure, thereby rendering the plurality of pixels in operation 520.

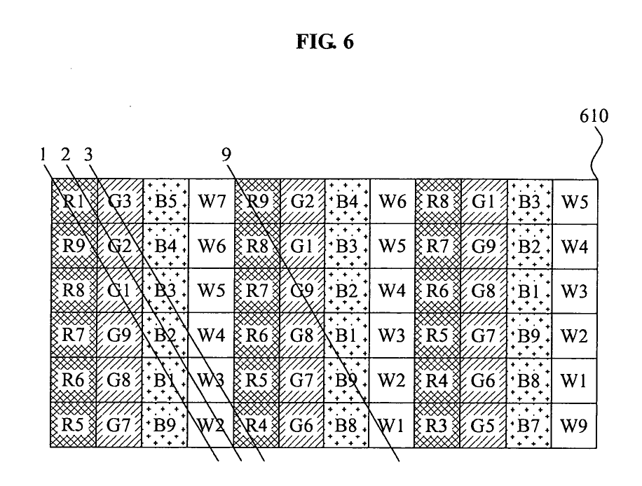

Hereinafter, the operations of rendering the plurality of pixels by grouping the plurality of RGBW sub pixels in the diagonal direction on the pixel structure are described in detail with respect to FIG. 6.

FIG. 6 is a diagram illustrating a pixel structure 610 in which sub pixels are arranged in a striped pattern according to an example embodiment.

In the pixel structure 610, each of sub pixels are arranged in a striped pattern in a diagonal direction.

According to example embodiments, a plurality of pixels which configure an image may be rendered by grouping the sub pixels in a diagonal direction on the pixel structure 610, such as (R1, G1, B1, W1), (G2, B2, W2, R2), (G3, B3, W3, R3), etc., in operation 520. In this instance, the pixel structure 610 may be used to render the plurality of pixels configuring a multi-view 3D image. Here, a line corresponding to (R1, G1, B1, W1) may correspond to first 3D pixel data at a first viewpoint of the multi-view 3D image.

The rendering method according to example embodiments may prevent crosstalk from occurring in a boundary of each viewpoint by forming the pixel structure 610 in the stripe pattern as shown in FIG. 6, since pixel data of each viewpoint in the multi-view 3D image are not horizontally adjacent to each other.

Also, in operation 520, the rendering method according to the example embodiments may render the plurality of pixels by grouping the plurality of RGBW sub pixels in a horizontal direction on the pixel structure 610.

Referring to FIG. 6, the plurality of pixels may be rendered by grouping the sub pixels in a horizontal direction on the pixel structure, such as (R1, G3, B5, W7), (R9, G2, B4, W6), etc. Here, the pixel structure 610 may be used to render a plurality of pixels which configure a 2D image.

Also, according to example embodiments, in operation 520, the plurality of pixels may be rendered by sharing sub pixels, which are adjacent to each other, on the pixel structure 610. In detail, when the plurality of RGBW sub pixels are grouped in the diagonal direction or grouped in the horizontal direction, a resolution of an image may be improved by sharing and grouping sub pixels which are adjacent to each other on a display.

The rendering method according to the above-described example embodiments may be recorded in computer-readable media including program instructions to implement various operations to be executed by a computer. The media may also include, alone or in combination with the program instructions, data files, data structures, etc. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, etc. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

1. A rendering method, comprising:
forming a pixel structure in which a plurality of red, green, blue, and white (RGBW) sub pixels is arranged in a checkerboard pattern; and
rendering a plurality of pixels which configure an image using the plurality of RGBW sub pixels on a display.

2. The method of claim 1, wherein the rendering of the plurality of pixels renders the plurality of pixels by sharing sub pixels which are adjacent to each other on the pixel structure.

3. The method of claim 1, wherein the rendering of the plurality of pixels renders the plurality of pixels by grouping the plurality of RGBW sub pixels in a diagonal direction on the pixel structure.

4. The method of claim 1, wherein the rendering of the plurality of pixels renders the plurality of pixels by grouping the plurality of RGBW sub pixels in a perpendicular direction on the pixel structure.

5. The method of claim 1, wherein the rendering of the plurality of pixels renders the plurality of pixels by grouping the plurality of RGBW sub pixels into the checkerboard pattern on the pixel structure.

6. A rendering method, comprising:
forming a pixel structure in which a plurality of RGBW sub pixels is arranged in a striped pattern; and
rendering a plurality of pixels which configure an image using the plurality of RGBW sub pixels on a display.

7. The method of claim 6, wherein the rendering of the plurality of pixels renders the plurality of pixels by sharing sub pixels which are adjacent to each other on the pixel structure.

8. The method of claim 6, wherein the rendering of the plurality of pixels renders the plurality of pixels by grouping the plurality of RGBW sub pixels in a diagonal direction on the pixel structure.

9. A computer readable recording medium encoded with a computer program causing a computer to execute the method, comprising:
forming a pixel structure in which a plurality of red, green, blue, and white (RGBW) sub pixels is arranged in a checkerboard pattern; and
rendering a plurality of pixels which configure an image using the plurality of RGBW sub pixels on a display.

10. Acomputer readable recording medium encoded with a computer program causing a computer to execute the method, comprising:
forming a pixel structure in which a plurality of RGBW sub pixels is arranged in a striped pattern; and
rendering a plurality of pixels which configure an image using the plurality of RGBW sub pixels on a display.
